(19) United States
(12) Patent Application Publication
(10) Pub. No.: US 2015/0002776 A1
(43) Pub. Date: Jan. 1, 2015

(54) WIDE VIEWING ANGLE LIQUID CRYSTAL DISPLAY REALIZING MULTI-DOMAIN DISPLAY

(71) Applicant: Truly Semiconductors Ltd., Shanwei, Guangdong (CN)

(72) Inventors: Junwen Hu, Shanwei (CN); Lin Li, Shanwei (CN); Shengbao Hong, Shanwei (CN); Chongying Zhuang, Shanwei (CN); Jiqiang He, Shanwei (CN)

(21) Appl. No.: 14/370,870

(22) PCT Filed: Jan. 5, 2013
(86) PCT No.: PCT/CN2013/070041

§ 371 Date: Jul. 7, 2014

(30) Foreign Application Priority Data
Jan. 5, 2012 (CN) 201210003529.X
Feb. 29, 2012 (CN) 201210050635.3

(51) Int. Cl. G02F 1/1362; G02F 1/1343; G02F 1/1368

(52) U.S. Cl. CPC G02F 1/136286; G02F 1/1368; G02F 1/134336; G02F 2001/134318; G02F 2001/134345
USPC 349/46

(57) ABSTRACT

A wide viewing angle liquid crystal display realizing multi-domain display comprises a plurality of pixels, wherein each pixel is connected to a corresponding common electrode (7), a corresponding pixel electrode (5), a corresponding source electrode (3) and a corresponding gate electrode (2) respectively, and a multi-direction planar electric field can be formed between the common electrode (7) and the pixel electrode (5), so that the electric field in a corresponding pixel is divided into multiple azimuths for realizing multi-domain arrangement of liquid crystal molecular. Therefore, gray-scale reversal phenomena at certain specific angles can be improved, the problem of color offset can be improved effectively, the effect of wide viewing angle can also be more uniform and stable, and the quality of a displayed picture can be further improved.

This application claims the priority to Chinese Patent Application No. 201210003529.X, entitled “WIDE VIEWING ANGLE LIQUID CRYSTAL DISPLAY”, filed with the Chinese Patent Office on Jan. 5, 2012; and Chinese Patent Application No. 201210050635.3, entitled “WIDE VIEWING ANGLE LIQUID CRYSTAL DISPLAY REALIZING MULTI-DOMAIN DISPLAY”, filed with Chinese Patent Office on Feb. 29, 2012, and which are hereby incorporated by reference in their entireties.

### FIELD

The present disclosure relates to the liquid crystal display technology, and particularly to a wide viewing angle liquid crystal display achieving multi-domain display.

### BACKGROUND

Thin Film Transistor (TFT) liquid crystal displays are increasingly used in modern life, such as a mobile phone display screen, a Note Book display screen, a MP3 display screen, a MP4 display screen, a GPS display screen, a LCD TV display screen. FIG. 1a and FIG. 1b are schematic layout diagrams of an electrode of a typical liquid crystal display. An amorphous silicon layer 1, a gate electrode layer 2, a source electrode layer 3, an upper protective layer 6 and a lower protective layer 6 are disposed on a glass substrate 4. Common electrodes 7 arranged at intervals 1′ are disposed on the upper protective layer 6. And a pixel electrode 5 is disposed between the upper protective layer 6 and the lower protective layer 6. The details for the basic structure and the operating principle of the liquid crystal display may refer to related documents, and will be omitted herein.

Currently, the requirement of people to the performance of the liquid crystal display becomes increasingly high, not only requiring an excellent color representation, but also pursuing further on a contrast and a viewing angle. That is, it is required to view the displayed image clearly from multiple viewing angles. Especially for an on-vehicle display product, a liquid display with a high contrast and a wide viewing angle is widely used. In this case, a wide viewing angle product becomes an inevitable requirement of the market, and the wide viewing angle display has become a popular liquid crystal display mode. In general, it is existed a high cost in adding a compensation film to achieve the wide viewing display. Alternatively, the viewing angle may be improved by plane switching of the liquid crystal molecules, in which the liquid crystal molecules to perform plane-rotating in a maximum angle by using a space thickness, a frictional strength and the change of the transverse drive voltage E between the common electrode and the pixel electrode, increasing the viewing angle.

A single domain structure is generally adopted in the existing liquid crystal display products, of which the common electrodes have a similar pattern structure. As shown in FIG. 2A to FIG. 2F, a plane electric field formed between the common electrode and the pixel electrode has a single direction, and the liquid crystal molecules are arranged only in a single domain mode, i.e., the liquid crystal molecules in a single pixel have a single orientation. In this single domain mode, in the case that the liquid crystal molecules are arranged and orientated, a color cast arises from the different transmittances of the liquid crystal molecules if viewed in different viewing angles, not fully satisfying the requirements of the market.

### SUMMARY

In view of the above mentioned, according to the present disclosure, it is provided a wide viewing angle liquid crystal display achieving multi-domain display. Therefore, gray-scale reversal at certain specific angles may be alleviated, and an issue of color cast may be effectively alleviated. Furthermore, the wide viewing angle effect may be more uniform and more stable, and improving the quality of a displayed picture. The solution is as follows.

A wide viewing angle liquid crystal display achieving multi-domain display including multiple pixels is provided according to the present disclosure. Each of the multiple sub-pixels is connected to a common electrode, a pixel electrode, a source electrode and a gate electrode. Multiple plane electric fields with different directions may be formed between the common electrode and the pixel electrode to cause an electric field in the pixel to have multiple azimuths to achieve a multi-domain arrangement of liquid crystal molecules.

A comb-shaped common electrode may be formed by generating multiple comb-teeth shaped common electrode hollowed lines.

Each of the common electrode hollowed lines of the common electrode may be bent to form the multiple plane electric fields with different directions between the common electrode and the pixel electrode.

Each of the common electrode hollowed lines of the common electrode may be shaped as a folding line to form the multiple plane electric fields with different directions between the common electrode and the pixel electrode.

Each of the common electrode hollowed lines of the common electrode may have a shape approximating to “Z”, “V” or “W”.

Each of the common electrode hollowed lines of the common electrode may have a same extension direction as a source line of the source electrode, and each of the common electrode hollowed lines of the common electrode is bent to form the multiple plane electric fields with different directions between the common electrode and the pixel electrode.

The source line of the source electrode may have a curve shape to reduce an influence of the common electrode on an area for rotating liquid crystal by using an edge electric field of a pixel.

The source line of the source electrode may have a same bending angle as each of the common electrode hollowed lines of the common electrode.

Each of the common electrode hollowed lines of the common electrode may have a same extension direction as a gate line, and each of the common electrode hollowed lines of the common electrode may be bent to from the multiple plane electric fields with different directions between the common electrode and the pixel electrode.

The gate line may have a curve shape to reduce an influence of the common electrode on an area for rotating liquid crystal by using an edge electric field of a pixel.

The gate line may have a same bending angle as each of the common electrode hollowed lines of the common electrode.

The multiple sub-pixels may be arranged in multiple rows and multiple columns to form a pixel matrix.

Compared with the existing technology, in the wide viewing angle liquid crystal display achieving multi-domain display provided by the present disclosure, the pattern structure of the comb-shaped common electrode is changed, i.e., the pattern of the common electrode is shaped as a folding line, and thus multiple plane electric fields with different directions are formed between the common electrode and the pixel electrode to make an electric field in one sub-pixel to have multiple azimuths to achieve the multi-domain arrangement of liquid crystal molecules. Therefore gray-scale reversal at certain specific angles may be alleviated, and an issue of color cast may be effectively alleviated. The wide viewing angle effect may be more uniform and more stable, further improving the quality of a displayed picture.

### BRIEF DESCRIPTION OF THE DRAWINGS

To make the embodiments of the present disclosure or the technology solutions in the prior art to be more clear, the accompany drawings to be used in the description of the embodiments or the prior art will be described briefly in the following. Apparently, the accompany drawings in the following description are merely a few of embodiments of the present disclosure. Other drawings may be acquired from these accompany drawings by the skilled in the art without any creative work.

FIG. 1A is a first layout diagram of an electrode of a liquid crystal display;

FIG. 1B is a second layout diagram of an electrode of a liquid crystal display;

FIG. 2A is a schematic diagram of a single pixel in a wide viewing angle liquid crystal display with a single domain structure;

FIG. 2B is a schematic pattern diagram of a gate electrode layer in a wide viewing angle liquid crystal display with a single domain structure;

FIG. 2C is a schematic pattern diagram of a source electrode layer in a wide viewing angle liquid crystal display with a single domain structure;

FIG. 2D is a schematic pattern diagram of a pixel electrode in a wide viewing angle liquid crystal display with a single domain structure;

FIG. 2E is a schematic pattern diagram of a common electrode in a wide viewing angle liquid crystal display with a single domain structure;

FIG. 2F is a schematic diagram of a wide viewing angle liquid crystal display with a single domain structure after the layers are overlapped;

FIG. 3A is a schematic diagram of a single pixel in a wide viewing angle liquid crystal display achieving multi-domain display according to a first embodiment of the present disclosure;

FIG. 3B is a schematic pattern diagram of a gate electrode layer in the wide viewing angle liquid crystal display achieving multi-domain display according to the first embodiment of the present disclosure;

FIG. 3C is a schematic pattern diagram of a source electrode layer in the wide viewing angle liquid crystal display achieving multi-domain display according to the first embodiment of the present disclosure;

FIG. 3D is a schematic pattern diagram of a pixel electrode in the wide viewing angle liquid crystal display achieving multi-domain display according to the first embodiment of the present disclosure;

FIG. 3E is a schematic pattern diagram of a common electrode in the wide viewing angle liquid crystal display achieving multi-domain display according to the first embodiment of the present disclosure;

FIG. 3F is a schematic pattern diagram of the wide viewing angle liquid crystal display achieving multi-domain display according to the first embodiment of the present disclosure after the layers are overlapped;

FIG. 3G is a schematic diagram of a pixel array in the wide viewing angle liquid crystal display achieving multi-domain display according to the first embodiment of the present disclosure;

FIG. 4A is a schematic diagram of a single pixel in a wide viewing angle liquid crystal display achieving multi-domain display according to a second embodiment of the present disclosure;

FIG. 4B is a schematic pattern diagram of a gate electrode layer in the wide viewing angle liquid crystal display achieving multi-domain display according to the second embodiment of the present disclosure;

FIG. 4C is a schematic pattern diagram of a source electrode layer in the wide viewing angle liquid crystal display achieving multi-domain display according to the second embodiment of the present disclosure;

FIG. 4D is a schematic pattern diagram of a pixel electrode in the wide viewing angle liquid crystal display achieving multi-domain display according to the second embodiment of the present disclosure;

FIG. 4E is a schematic pattern diagram of a common electrode in the wide viewing angle liquid crystal display achieving multi-domain display according to the second embodiment of the present disclosure;

FIG. 4F is a schematic pattern diagram of the wide viewing angle liquid crystal display achieving multi-domain display according to the second embodiment of the present disclosure after the layers are overlapped;

FIG. 4G is a schematic diagram of a pixel array in the wide viewing angle liquid crystal display achieving multi-domain display according to the second embodiment of the present disclosure;

FIG. 5 is a schematic pattern diagram of a common electrode corresponding to a single pixel in a wide viewing angle liquid crystal display achieving multi-domain display according to a third embodiment of the present disclosure; and

FIG. 6 is a schematic pattern diagram of a common electrode corresponding to a single pixel in a wide viewing angle liquid crystal display achieving multi-domain display according to a fourth embodiment of the present disclosure.

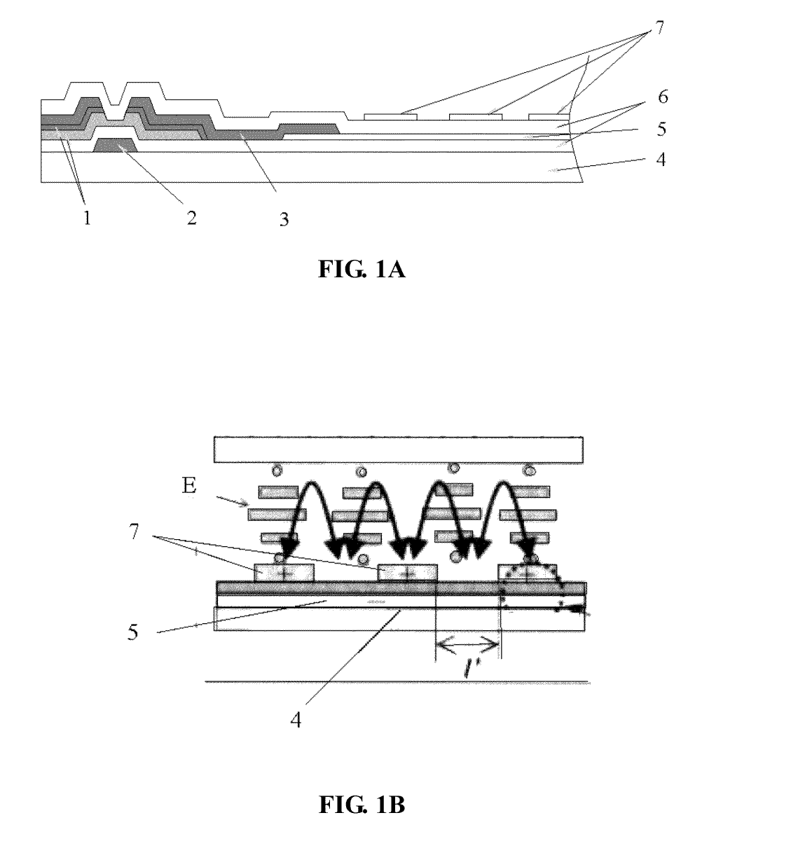

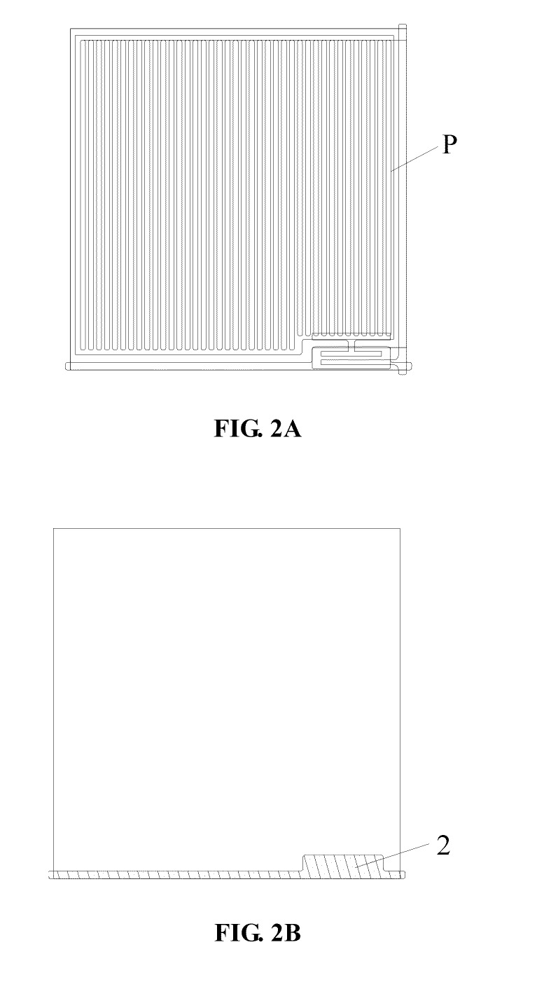

### DETAILED DESCRIPTION

To solve the issue in the conventional technology, according to the embodiments of the present disclosure, it is provided a wide viewing angle liquid crystal display achieving multi-domain display including multiple pixels. Each of the pixels is connected to a common electrode, a pixel electrode, a source electrode and a gate electrode. Multiple plane electric fields with different directions may be formed between the common electrode and the pixel electrode to cause an electric field in a corresponding pixel to have multiple directions for achieving a multi-domain arrangement of liquid crystal molecules.

It should be noted that multiple sub-pixels are arranged in multiple rows and multiple columns to form a pixel matrix.

It should be understood that in practice a comb-shaped common electrode is formed by generating multiple comb-teeth shaped common electrode hollowed lines. In order to make the liquid crystal display to be arranged in multiple domains, the common electrode hollowed lines of the common electrode may be respectively bent to form a multidirectional plane electric field between the common electrode and the pixel electrode. Of course, the way to form the multidirectional plane electric field between the common electrode and the pixel electrode is not limited in bending the common electrode hollowed lines of the common electrode.

Specifically, each of the common electrode hollowed lines of the common electrode may be shaped as a folding line to from a multidirectional plane electric field between the common electrode and the pixel electrode. It should be understood that in practice each of the common electrode hollowed lines of the common electrode is approximately shaped as “Z”, “V” or “W”, which is not limited thereto.

It should be noted that each of the common electrode hollowed lines of the common electrode may have a same extension direction as a source line of the source electrode. In this case, the source line of the source electrode may be shaped as a curve to reduce an influence of the common electrode on an area for rotating liquid crystal by using an edge electric field of a pixel. Preferably, the source line of the source electrode has a same bending angle as each of the common electrode hollowed lines of the common electrode.

Similarly, each of the common electrode hollowed lines of the common electrode may have a same extension direction as a gate line for supplying a voltage to turn on a TFT transistor. In this case, the gate line may be shaped as a curve to reduce an influence of the common electrode on an area for rotating liquid crystal by using the edge electric field of the pixel. Preferably, the gate line may have a same bending angle as each of the common electrode hollowed lines of the common electrode.

In summary, according to the basic idea of the preferable embodiment of the present disclosure, the pattern structure of the comb-shaped common electrode is changed, and specially the pattern of the common electrode is shaped as a folding line, in this case, a multidirectional plane electric field is formed between the common electrode and the pixel electrode to make an electric field in one sub-pixel to have multiple azimuths to achieve a multi-domain arrangement of liquid crystal molecules. Therefore, gray-scale reversal at certain specific angles is alleviated, and an issue of color cast is effectively alleviated. The wide viewing angle effect is more uniform and more stable, further improving the quality of a displayed picture.

In order to make the skilled in the art to understand the technical solution of the present disclosure better, the embodiments of the present disclosure will be described in detail below in conjunction with the accompany drawings.

### First Embodiment

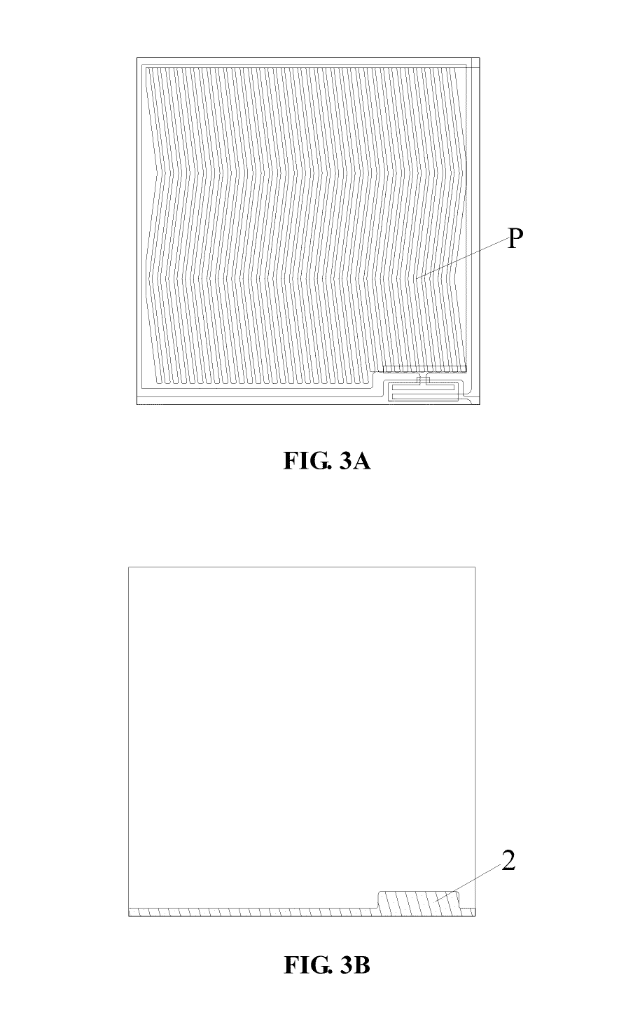

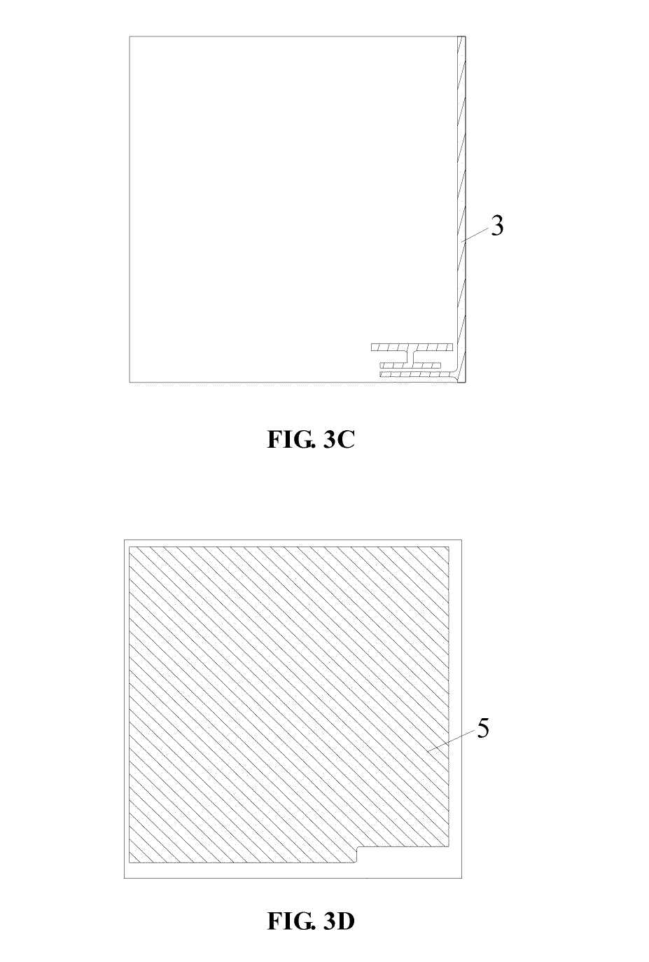

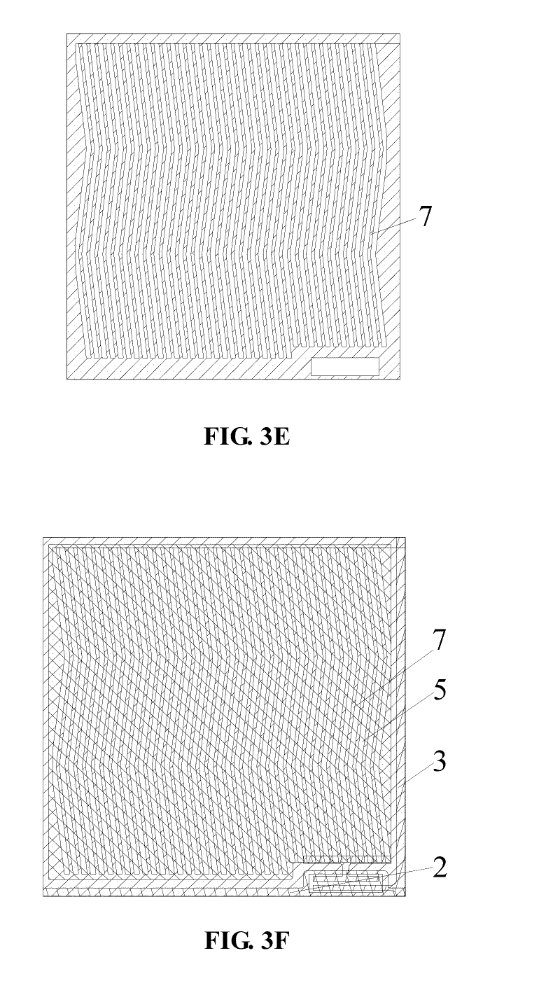

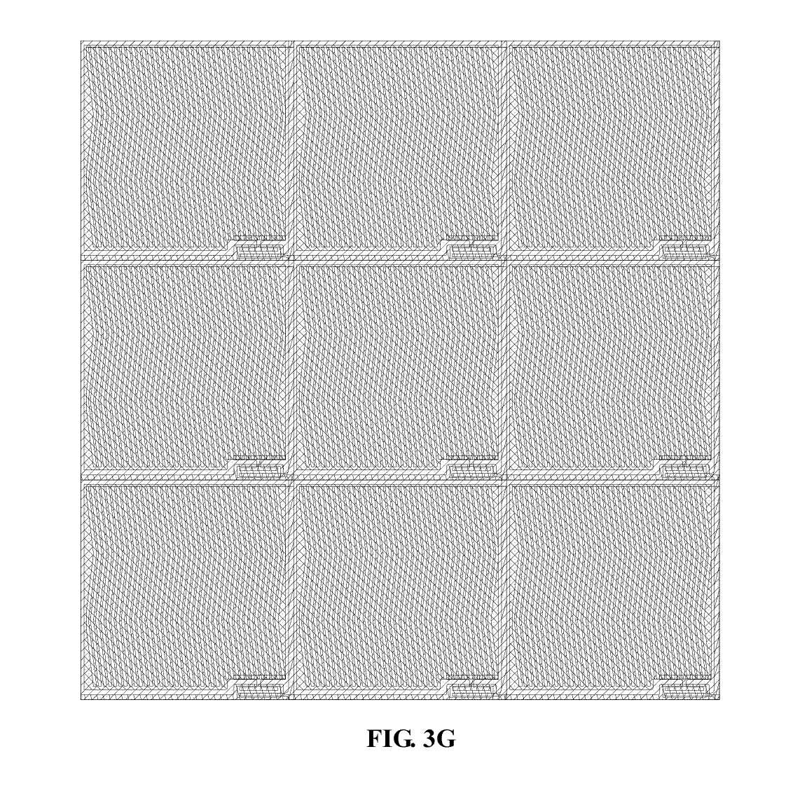

FIG. 3A to FIG. 3G show an electrode structure arrangement of a wide viewing angle liquid crystal display achieving multi-domain display according to a first embodiment of the present disclosure. Specifically, FIG. 3A is a schematic diagram of a single pixel; FIG. 3B is a schematic pattern diagram of a gate electrode layer 2; FIG. 3C is a schematic pattern diagram of a source electrode layer 3; FIG. 3D is a schematic pattern diagram of a pixel electrode 5; FIG. 3E is a schematic pattern diagram of a common electrode 7; FIG. 3F is a schematic diagram of the layers overlapped with each other; and FIG. 3G is a schematic diagram of a pixel array.

In this embodiment, the common electrode 7 is formed by generating multiple comb-teeth shaped common electrode hollowed lines. The common electrode has a shape approximating to “Z”. Of course, the common electrode 7 may have a folding line shape of “V”, “W” or the like, or other curve shapes. An intersection angle formed between the comb-shaped common electrode 7 and the pixel electrode 5 has multiple different angles to acquire plane electric field with multiple different angles, and thus the liquid crystal molecules are arranged in multiple domains.

It should be noted that in practice since the common electrode is made of ITO, the common electrode is formed by ITO lines arranged at intervals by means of the common electrode hollowed lines, and there is no ITO metal line at the common electrode hollowed lines. It should be understood that in this embodiment both the common electrode hollowed lines and the ITO lines have a shape approximating to “Z”, and thus the common electrode has a pattern approximating to “Z”.

In this embodiment, a multidirectional plane electric field is formed between the common electrode 7 and the pixel electrode 5 to make an electric field in a pixel P to have multiple azimuths, and thus a multi-domain arrangement of liquid crystal molecules is achieved. Therefore the gray-scale reversal at certain specific angles is alleviated, and thus an issue of color cast is effectively alleviated. The wide viewing angle effect is more uniform and more stable, further improving the quality of a displayed picture.

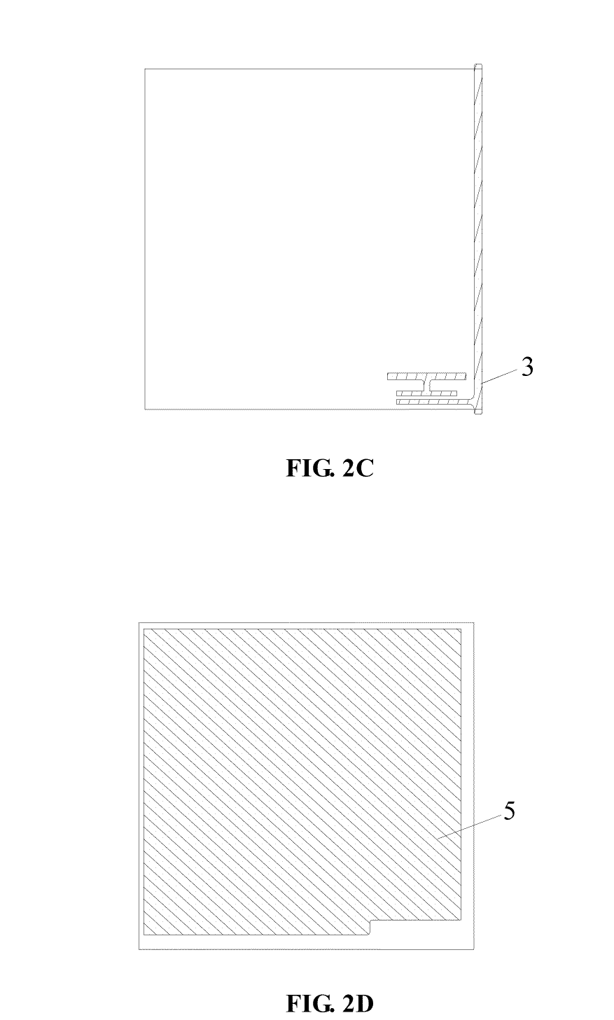

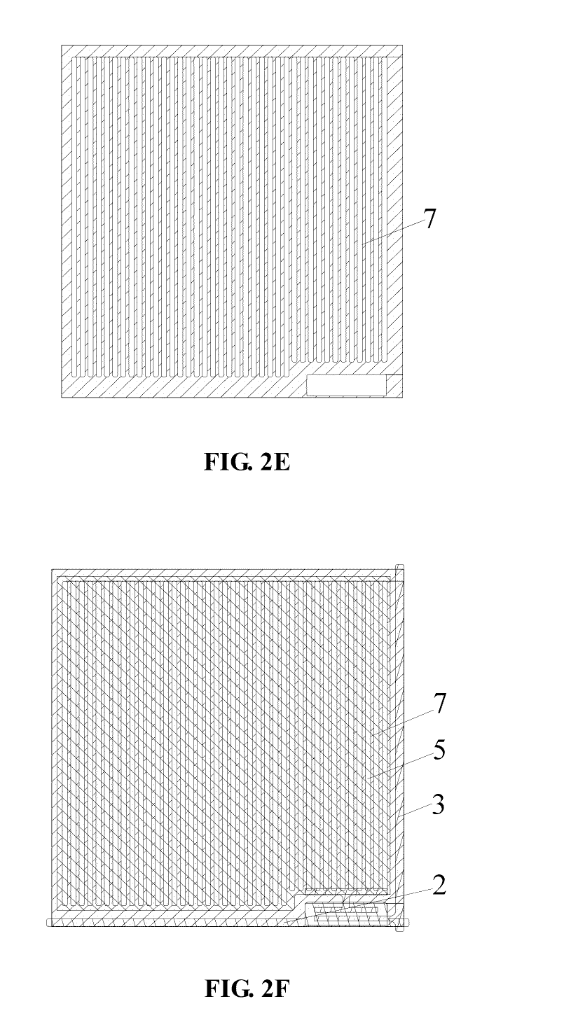

In contrast, in the pattern of the common electrode with a single domain structure shown in FIG. 2A to FIG. 2F, a plane electric field formed between the common electrode 7 and the pixel electrode 5 has a single direction, and the liquid crystal molecules are arranged only in a single domain mode. The color cast arises if viewing in different viewing angles, not satisfying the users' requirements well.

Since the gray-scale reversal at certain specific angles may be alleviated according to this embodiment, an issue of color cast may be effectively alleviated. The wide viewing angle effect may be more uniform and more stable, further greatly improving of the quality of a displayed picture.

### Second Embodiment

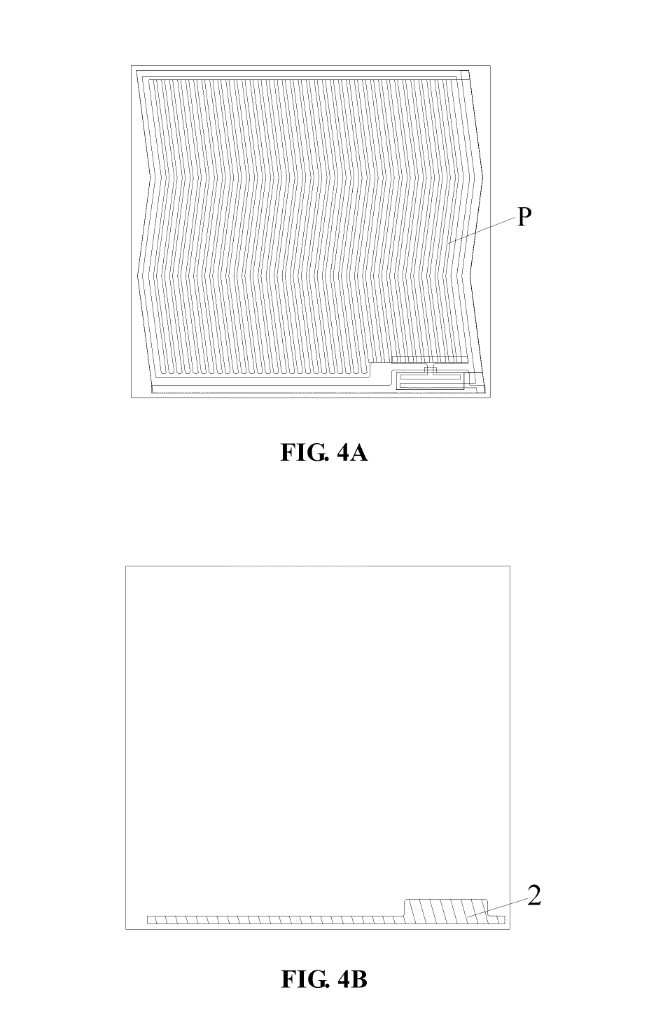

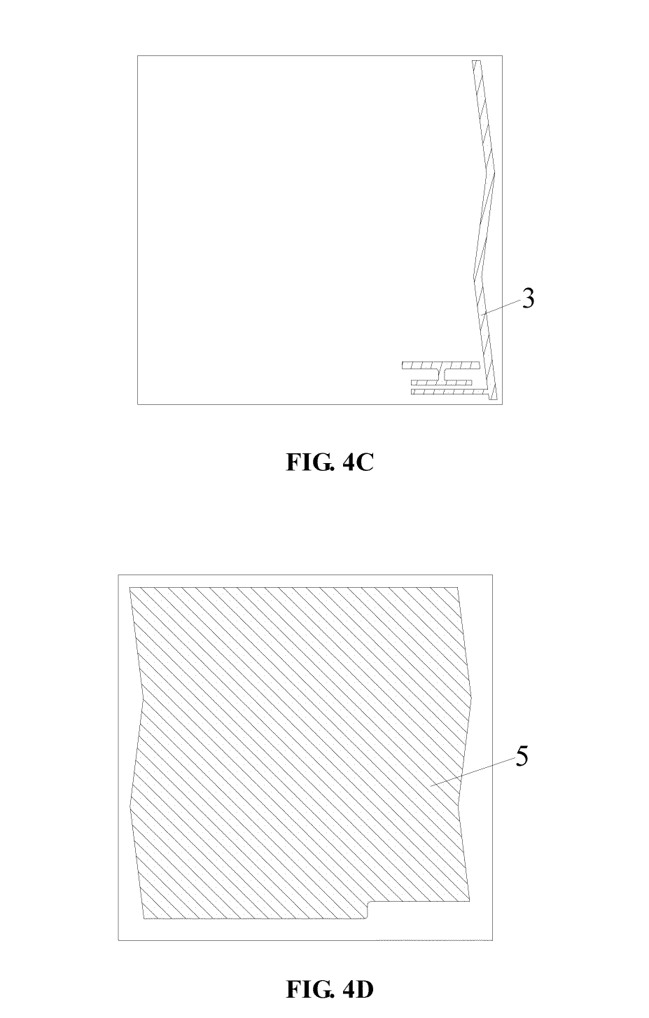

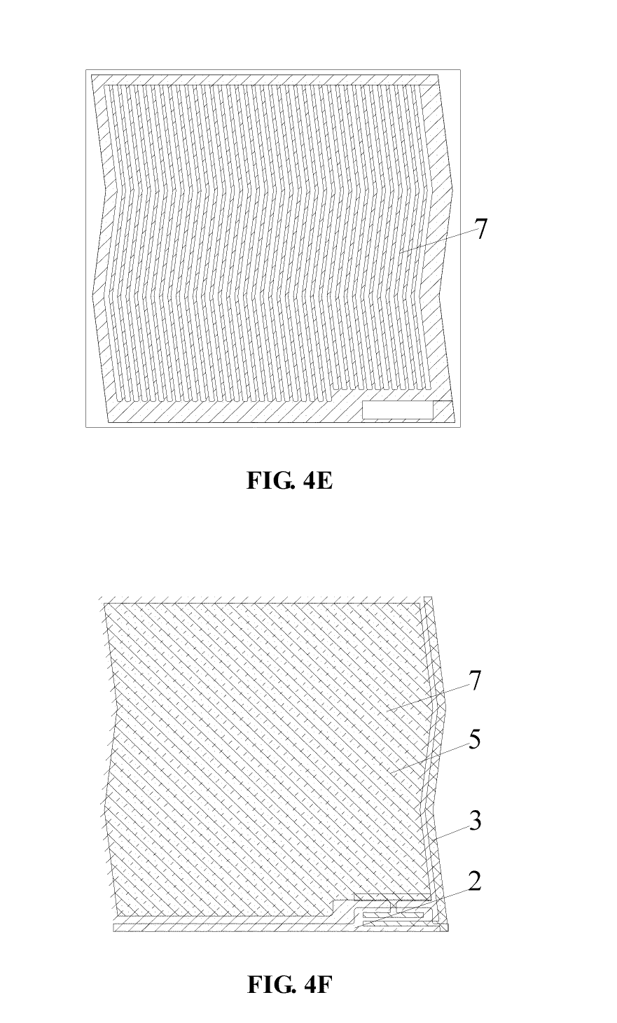

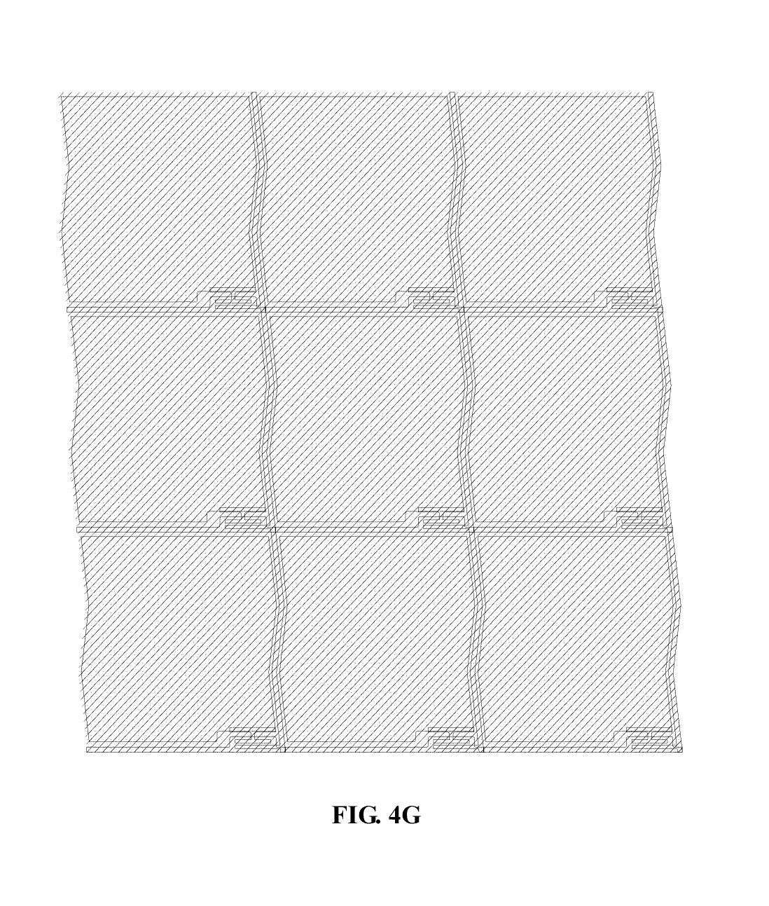

FIG. 4A to FIG. 4G show the electrode structure arrangement of a wide viewing angle liquid crystal display achieving multi-domain display according to a second embodiment of the present disclosure. Specifically, FIG. 4A is a schematic diagram of a single pixel; FIG. 4B is a schematic pattern diagram of a gate electrode layer 2; FIG. 4C is a schematic pattern diagram of a source electrode layer 3; FIG. 4D is a schematic pattern diagram of a pixel electrode; FIG. 4E is a schematic pattern diagram of a common electrode; FIG. 4F is a schematic pattern diagram of the layers overlapped with each other; and FIG. 4G is a schematic diagram of a pixel array.

In this embodiment, the common electrode has a “Z” shape or the approximate shape. Multiple different angles formed between the comb-shaped common electrode 7 and the pixel electrode 5 to form multiple plane electric fields with different directions, and thus the liquid crystal molecules are arranged in multiple domains. It should be noted that in practice since the common electrode is made of ITO, the common electrode is formed by lines arranged at intervals by means of the common electrode hollowed lines, and there is no ITO line at the common electrode hollowed lines. It should be understood that in this embodiment both the common electrode hollowed lines and the ITO lines have a shape approximating to “Z”, and thus the common electrode has a pattern approximating to “Z”.

Furthermore, in the pixel P, a source line of the source electrode has a same bending angle as each of the common electrode hollowed lines. That is, the source line is parallel with the common electrode hollowed lines. In this case, an influence of the pattern bending of the common electrode 7 on an area for rotating liquid crystal is not too great by effectively using the edge electric field of the pixel P, i.e., an opening ratio of the pixel P is ensured indirectly. It should be understood that since each of the common electrode hollowed lines is parallel with the ITO line, the source line is parallel with the ITO line.

In view of the above mentioned, since the comb-shaped common electrode 7 according to the first embodiment is approximately shaped as “Z”, multiple plane electric fields with different directions are formed between the common electrode and the pixel electrode. The liquid crystal molecules are rotated regularly toward different directions under the effect of the electric fields in different directions to form a multi-domain arrangement. The greater viewing angle is compensated by arranging the liquid crystal molecules in multiple domains, and thus the fluctuation of the light transmittance under the tilt angle is reduced. Therefore, the issue of color cast is effectively alleviated, the uniform and stable picture may be viewed from different viewing angles, and quality of a displayed picture may be further improved. Furthermore, based on the first embodiment, the design of the source line and the common electrode hollowed lines having a same bending angle is still taken into account in the second embodiment. With this design, the influence of the pattern bending of the common electrode on the using of the pixel electric field may be reduced, and the pixel space may be more effectively used. The utilization of the electric field is ensured, and the area for rotating liquid crystal is ensured, i.e., the opening ratio of the pixel P is ensured indirectly to make the display to be better. Combining the two points described above, the quality of a displayed picture may be further improved.

### Third Embodiment

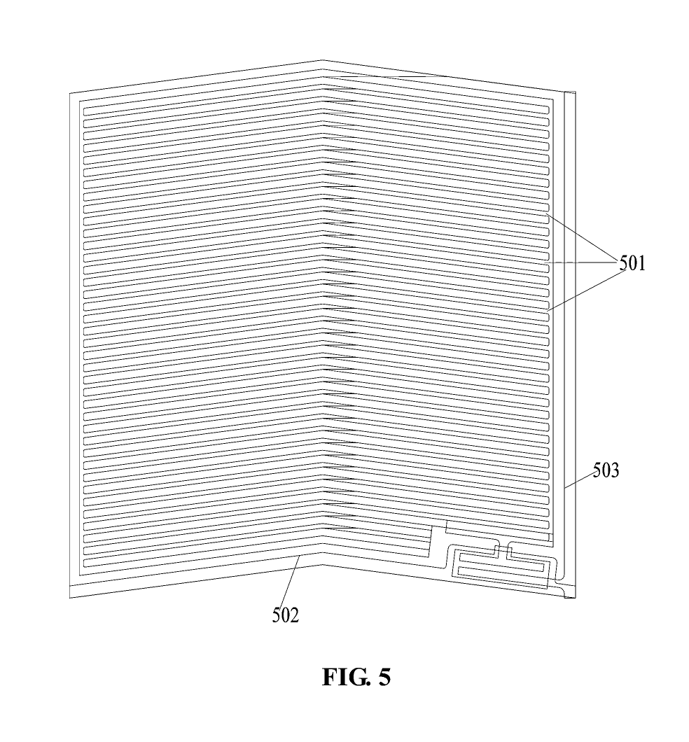

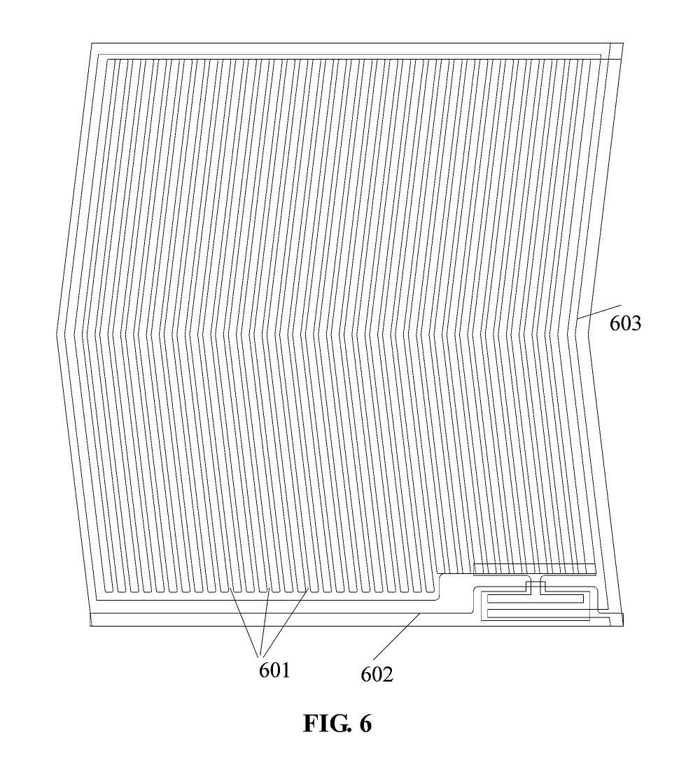

FIG. 5 is a schematic pattern diagram of a common electrode corresponding to a single pixel. Each of the common electrode hollowed lines may have a same extension direction as a gate line 502 for supplying a voltage to turn on the TFT transistor, and have a different extension direction from a source line 502 of the source electrode. In this embodiment, the comb-shaped common electrode corresponding to a single pixel is formed by generating multiple comb-teeth shaped common electrode hollowed lines. The common electrode has an shape approximating to an inverted “V”, i.e., the common electrode hollowed line is extended in the lateral direction, and has a shape of a folding line of a central symmetry inverted “V” consisted of two line segments. Therefore, in the case that the pixel electrode and the common electrode are charged, the formed electric fields have multiple directions and the liquid crystal molecules are rotated regularly toward different directions under the effect of the electric fields in different directions to form a multiple domain arrangement. The greater viewing angle is compensated better by arranging the liquid crystal molecules in multiple domains, and thus the fluctuation of the light transmittance under the tilt angle is reduced. Therefore, the issue of color cast is effectively alleviated. In short, multiple different angles formed between the comb-shaped common electrode and the pixel electrode to form multiple plane electric fields with different angles, and the liquid crystal molecules are arranged in multiple domains.

It should be noted that in practice since the common electrode is made of ITO, the common electrode is formed by ITO lines 501 arranged at intervals by means of the common electrode hollowed lines, and there is no ITO line at the common electrode hollowed lines. It should be understood that in this embodiment both the common electrode hollowed lines and the ITO lines 501 have an shape approximating to an inverted “V”, and thus the common electrode has an pattern approximating to an inverted “V”.

It should be understood that under the premise of ensuring that the electric fields formed between the pixel electrode and the common electrode have stable multiple directions, the shape of the common electrode hollowed lines extending in the lateral direction as shown in FIG. 5 is not limited to the inverted “V” described in this embodiment, for example, a folding line of a central symmetry “V” consisted of two line segments, a folding line of a central symmetry “W” or inverted “W” consisted of four line segments.

Furthermore, in order to use the pixel electric field and the pixel space better to ensure the utilization of the electric field, as shown in FIG. 5, the gate line 502 may be disposed to have a same bending angle as the pattern of the common electrode hollowed line, i.e., the gate line is parallel with each of the common electrode hollowed lines. The area for rotating liquid crystal is ensured by changing the shape of the gate line 502, and the opening ratio of the pixel is ensured indirectly, improving effectively the display effect of the wide viewing angle liquid crystal display. It should be understood that since each of the common electrode hollowed lines is parallel with the ITO line 501, the gate line 502 is also parallel with the ITO line.

### Fourth Embodiment

FIG. 6 shows a schematic pattern diagram of a common electrode corresponding to a single pixel. Each of the common electrode hollowed lines may have a same extension direction as a source line 603 of the source electrode, and have a different extension direction from a gate line 602. In this embodiment, the comb-shaped common electrode corresponding to a single pixel is formed by generating multiple comb-teeth shaped common electrode hollowed lines. Specifically, each of the common electrode hollowed lines is extended in a longitudinal direction and has a shape of a central symmetry folding line consisted of two line segments. Therefore in the case that the pixel electrode and the common electrode are charged, the formed electric fields have multiple directions, and the liquid crystal molecules are rotated regularly toward different directions under the effect of the electric fields in different directions to form a multiple domain arrangement. The greater viewing angle is compensated better by arranging the liquid crystal molecules in multiple domains, and thus the fluctuation of the light transmittance under the tilt angle is reduced. Therefore, the issue of color cast is effectively alleviated. In short, multiple different angles formed between the comb-shaped common electrode and the pixel electrode to form multiple plane electric fields with different directions, and thus the liquid crystal molecules are arranged in multiple domains.

It should be noted that in practice since the common electrode is made of ITO, the common electrode is formed by ITO lines 601 arranged at intervals by means of the common electrode hollowed lines, where there is no ITO line at the common electrode hollowed lines. It should be understood that in this embodiment both the common electrode hollowed lines and the ITO lines 601 have a shape a central symmetry folding line extended in a longitudinal direction and consisted of two line segments, and thus the common electrode has a pattern as shown in FIG. 6.

It should be understood that under the premise of ensuring that the electric fields formed between the pixel electrode and the common electrode have stable multiple directions, the shape of the common electrode hollowed lines extending in the longitudinal direction as shown in FIG. 6 is not limited to the folding line shape described in this embodiment, for example, a folding line of a central symmetry curve shape consisted of two line segments, a central symmetry folding line consisted of four line segments.

Furthermore, in order to use the pixel electric field and the pixel space better to ensure the utilization of the electric field, as shown in FIG. 6, the source line 603 may be disposed to have a same bending angle as the pattern of the common electrode hollowed line, i.e., the gate line 603 is parallel with each of the common electrode hollowed lines. The area for rotating liquid crystal is ensured by changing the shape of the source line 603, and the opening ratio of the pixel is ensured indirectly, improving effectively the display effect of the wide viewing angle liquid crystal display. It should be understood that since each of the common electrode hollowed lines is parallel with the ITO line 601, the source line 603 is also parallel with the ITO line 601.

In the above embodiments, the viewing angle may be improved by plane switching the liquid crystal molecules, the liquid crystal molecules have a maximum plane rotation angle by using an appropriate space thickness and a frictional strength, and by effectively using the change of the transverse drive voltage, and thus increasing the viewing angle. The advantage of this manner is in that there is no need to add additionally a compensation film during the manufacturing product, and there is a high contrast in the visual display, achieving the wide viewing angle effect in the aspect of the rising viewing angle.

The embodiments are merely preferred embodiments of the present disclosure. It should be noted that, the preferred embodiments should not be regarded as limiting the present disclosure, and the protection scope of the present disclosure should be defined by the claims. Also, numerous variations and modifications may be made by those skilled in the art without departing from the sprit and scope of the disclosure, and these variations and modifications will fall into the protection scope of the disclosure.

1. A wide viewing angle liquid crystal display achieving multi-domain display, comprising a plurality of sub-pixels, wherein each of the sub-pixels comprises a common electrode, a pixel electrode, a source electrode and a gate electrode, wherein a plurality of plane electric fields with different directions are formed between the common electrode and the pixel electrode to cause an electric field in the sub-pixel to have a plurality directions for achieving a multi-domain arrangement of liquid crystal molecules.

2. The wide viewing angle liquid crystal display achieving multi-domain display according to claim 1, wherein a comb-shaped common electrode is formed by generating a plurality of comb-teeth shaped common electrode hollowed lines.

3. The wide viewing angle liquid crystal display achieving multi-domain display according to claim 2, wherein each of the common electrode hollowed lines of the common electrode is bent to form the plurality of plane electric fields with different direction between the common electrode and the pixel electrode.

4. The wide viewing angle liquid crystal display achieving multi-domain display according to claim 3, wherein each of the common electrode hollowed lines of the common electrode is shaped as a folding line to form the plurality of plane electric fields with different directions between the common electrode and the pixel electrode.

5. The wide viewing angle liquid crystal display achieving multi-domain display according to claim 4, wherein each of the common electrode hollowed lines of the common electrode has a shape approximating to “Z”, “V” or “W”.

6. The wide viewing angle liquid crystal display achieving multi-domain display according to claim 3, wherein each of the common electrode hollowed lines of the common electrode has a same extension direction as a source line of the source electrode, and each of the common electrode hollowed lines of the common electrode is bent to form the plurality of plane electric fields with different directions between the common electrode and the pixel electrode.

7. The wide viewing angle liquid crystal display achieving multi-domain display according to claim 6, wherein the source line of the source electrode has a curve shape to reduce an influence of the common electrode on an area for rotating liquid crystal by using an edge electric field of a pixel.

8. The wide viewing angle liquid crystal display achieving multi-domain display according to claim 7, wherein the source line of the source electrode has a same bending angle as each of the common electrode hollowed lines of the common electrode.

9. The wide viewing angle liquid crystal display achieving multi-domain display according to claim 3, wherein each of the common electrode hollowed lines of the common electrode has a same extension direction as a gate line, and each of the common electrode hollowed lines of the common electrode is bent to form the plurality of plane planar electric fields with different directions between the common electrode and the pixel electrode.

10. The wide viewing angle liquid crystal display achieving multi-domain display according to claim 9, wherein the gate line has a curve shape to reduce an influence of the common electrode on an area for rotating liquid crystal by using an edge electric field of a pixel.

11. The wide viewing angle liquid crystal display achieving multi-domain display according to claim 10, wherein the gate line has a same bending angle as each of the common electrode hollowed lines of the common electrode.

12. The wide viewing angle liquid crystal display achieving multi-domain display according to claim 1, wherein the sub-pixels are arranged in a plurality of rows and a plurality of columns to form a pixel matrix.
